(19) United States
(12) Patent Application Publication
(10) Pub. No.: US 2006/0036532 A1
(43) Pub. Date: Feb. 16, 2006

(54) Methods and apparatus for executing small size orders

(76) Inventors: Andrew F. Silverman, Holmdel, NJ (US); Jatin Suryawanshi, Holmdel, NJ (US)

Correspondence Address: BUCKLEY, MASCHOFF, TALWALKAR LLC, 5 ELM STREET, NEW CANAAN, CT, 06840, US

(21) Appl. No.: 11/181,956

(22) Filed: Jul. 14, 2005

Related U.S. Application Data
(60) Provisional application No. 60/587,766, filed on Jul. 14, 2004.

(51) Int. Cl. G06Q 40/00

(52) U.S. Cl. 705/37

(57) ABSTRACT

A method and system for executing a small size trade, the method including, in some embodiments, receiving a limit order associated with a security trade order to be forwarded to at least one order execution destination, the security trade order comprising a security to be traded and an order size, determining a specified period of time within which to attempt to execute the trade order, and converting the limit order to a market order in response to an expiration of the time and at least a portion of the o

[symbol]

### CROSS REFERENCE TO RELATED APPLICATION

This application claims benefit of and priority to U.S. Provisional Patent Application Ser. No. 60/587,766, filed on Jul. 14, 2004, entitled “METHODS AND APPARATUS FOR EXECUTING SMALL SIZE ORDERS”, the contents of which are incorporated herein by reference for all purposes.

### FIELD

The present invention relates to execution strategies for electronic trading of stocks and other financial instruments. In some embodiments, the present invention relates to methods and apparatus for executing small size orders.

### BACKGROUND

Various forms of electronic trading platforms are utilized presently by market participants and financial service firms. Generally, electronic trading allows traders to place buy and sell orders through a user device such as a desktop computer.

Architectures of such electronic trading systems vary widely. In some systems, a trader interacts directly with an electronic trading platform presented by the user device. The electronic trading platform may be an internally-developed system, a commercially available off-the-shelf system, or a modified commercially available system customized to specific client and/or trader needs. The electronic trading platform may communicate with pools of liquidity directly or through a routing and order management network. Such pools of liquidity, which may also be thought of as trading market places, include listed exchanges, ECNs (Electronic Communication Networks), market makers, options exchanges, futures exchanges, and the like. An electronic trading platform and/or management network may also communicate with in-house back-end systems to provide trade reporting and tracking functions to the trader.

Many electronic trading platforms and management networks are currently available, each providing specific features. Many of these features are intended to clearly market information to a trader, and others are intended to facilitate automated or semi-automated trading functions.

However, there exists a need to efficiently and cost effectively execute trading of small size security orders to achieve a desired trading strategy.

### SUMMARY

To address the foregoing, embodiments of the present invention concern a method, an apparatus, and a medium storing processor-executable process steps to determine, during an execution of a trade, a period of time within which to execute the trade to capture an improved spread or price improvement. In some embodiments, in an instance the spread associated with the trade being executed moves away from the trader, the trade order may be converted to a market order.

As used herein, “order destination” refers to any one or more of a securities exchange, a market maker and an ECN; and “trading session” includes one or both of (a) a calendar day, and (b) a period during a calendar day during which a market or ECN is open for trading.

In some aspects, the specified time within which the trade order is to be executed may be bound by an upper time limit and a lower time limit. The upper time limit may provide a maximum time for executing the trade, in an effort to capture an improved spread. The lower time limit may provide a minimum measure of time to wait prior to executing the trade order to facilitate a potential movement in the spread associated with the trade order.

Thus, in some aspects, a small size trade order execution strategy may be based on information, in addition to the security being traded and a size of the order, a time for executing the trade order to capture an improved spread position, and a mechanism to convert the trade order to a market order in response to an expiration of time and/or a spread movement away from a trader or market maker.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is an exemplary block diagram of a system, a trading network, according to some embodiments herein;

FIG. 2 is an exemplary illustration of an order processing server, in accordance with the trading network of FIG. 1;

FIG. 3 is an exemplary illustration of a user device, in accordance with the trading network of FIG. 1;

FIG. 4 is a flow diagram that illustrates an exemplary process for executing a small size trade of a desired securities order, in accordance with some embodiments herein; and

FIGS. 5A and 5B are flow diagrams of an exemplary process in accordance with some embodiments herein.

### DETAILED DESCRIPTION

In general, and for the purposes of introducing concepts of the present invention, data regarding one or more attributes of a security being traded may be updated during a trading session. The data may generally relate to a liquidity associated with the security, and may include historical data and dynamically updated, current market data. The data may be obtained from one or more electronic limit order books, order destinations, markets, exchanges, and other sources of data including stored data and developing data streams. The data, in some embodiments, is used during the execution of the trade efficiently and systematically capture favorable movements in a spread associated with the security being traded.

For example, small size orders may execute at a price that is better than the quoted price at the time an order is placed. That is, the quoted spread, the difference between the best bid and the best offer at the time the order is placed, may not be the best price that may be achieved at the time the trade is actually executed. Price improvements may be had based on, for example, liquidity inside the quote. Thus, after placement of an order at a quoted limit price, the spread that is realized by an order upon execution may be improved. In some embodiments herein, a specified time allotted to execute a trade is varied in an attempt to capture an improved spread position for the trade. The specified time may be based, in part, on the volatility of the traded security, the frequency with which the security is traded, an aggressiveness (or non-aggressiveness) of a trader or other entity executing the trade.

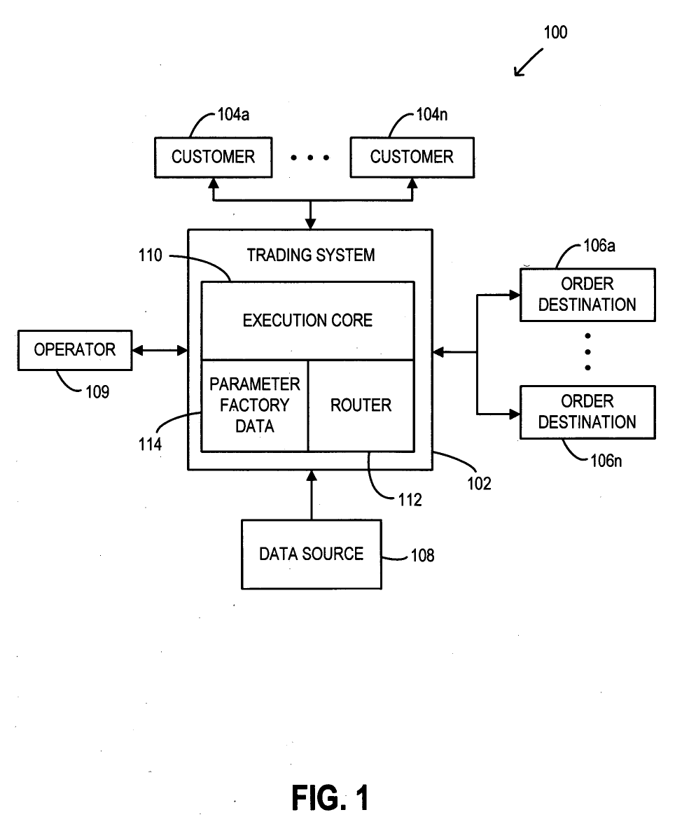

Features of some embodiments of the present invention will now be described by first referring to FIG. 1 where a block diagram of one embodiment of a trading network 100 is shown. As shown, trading network 100 includes a number of different components that cooperatively operate to process, route and execute securities trading orders pursuant to some embodiments of the present invention.

As depicted, trading network 100 includes a trading system 102 in communication with one or more customer(s) 104, a plurality of order destinations 106, a source 108 of order destination data, and one or more operator devices 109 (only one shown). Trading system 102, in some embodiments, includes an execution core 110, a router 112 and parameter factory data 114. Execution core 110 may be any trading execution software, systems and/or devices that are configured to receive customer orders and process them to execute orders on behalf of customers. In accordance with some trading strategies herein, execution core 110 may function to timestamp orders when received and to assign an order identifier or sequence number to each order.

Router 112 may be configured to receive an order from execution core 110 or to receive information about an order and to make a determination as to how the order is to be routed. That is, the router 112 determines an order destination or order destinations to which the order is to be routed, and if the order is to be divided among two or more order destination, the router 112 determines the respective proportions of the order to be allocated to the order destinations. Details of the operation of router 112 will be discussed below. The router may execute the routing decision that it makes, or may provide information concerning the routing decision to the execution core 110 to allow the execution core 110 to execute the order in accordance with the routing decision made by router 112.

Parameter factory data 114 operates to receive from data source 108 data concerning the security being traded and to maintain and update databases concerning the security based on the data received from data source 108. As will be seen, the databases may also reflect data derived from direct experience of the trading system 102 in dealing with the order destinations 106 and historical data associated with the security. Parameter factory data 114 may receive at least some of the data for the databases, and may analyze the data and update the databases, on a dynamic basis during each trading session. The databases are accessible to router 112 and the routing decisions made by router 112 may be based, at least in part, on the data in the databases.

In some embodiments, parameter factory data 114 may include such information as a trading frequency of a security. The trading frequency may be represented by an average time between trades of the security over a period of time. For example, an average number of trades for a security, XYZ, over a 10 day period may be included in or provided to parameter factory data 114. Based on this data for the security, an average time between trades, in seconds, may be calculated for the security in accordance with some systems and methods herein. (e.g., an algorithm may be used to determine the average time, in seconds, between trades (n/(390*60)). Lets call the average time between trades of the security, μ.

Accordingly, the following calculations may used to process an order in accordance with some embodiments herein.
(1) A minimum wait time, MinWaitTime (e.g., default=2μ, Minimum=2 seconds); and
(2) A maximum wait time, MaxWaitTime (e.g., default=10μ. (i.e., the system and method may be at an inside quote for a maximum of 10μ or 10 seconds.)).

In some embodiments, if the trade order is not filled within the MaxWaitTime period of time, the system is operated to more aggressively fill the order.

Pursuant to some embodiments, the two parameters MinWaitTime and MaxWaitTime may be adjusted or set by a trader, administrator directly, indirectly, manually, electronically (e.g., triggered) during a runtime of the trading transaction. Thus, a trader, market maker, or specialist may have the option to selectively make a trading algorithm or trading strategy of some embodiments herein more or less aggressive based on client, an order size, and other factors.

Pursuant to some embodiments, benefits of using this logic include: (1) providing the order as much time as prudent to capture the spread—if the stock moves in the trader's (market maker, or specialist's) favor; and (2) providing a mechanism for a rule-based logic to convert a limit order to a market if, for example, the stock moves away from a market maker, trader, etc. (i.e., less favorable) or if the order is taking longer than normal or desired to execute.

Although a single trading system 102 is shown in FIG. 1, any number of trading systems may be included in trading network 100. Similarly, any number of data sources 108, customer devices 104, order destinations 106, operator devices or any other device described herein may be included in the trading network 100 according to embodiments of the present invention.

Each of the devices of trading network 100 may be formed of components or other devices capable of performing the various functions described herein. For example, a customer device 104 may be a computing device such as a personal computer (PC), a laptop, a telephone, or other device associated with a customer. As used herein, the term “customer” may refer to, for example, an individual or other entity that buys and sells securities (and pursuant to some embodiments of the present invention, options; for purposes of this disclosure and the appended claims “securities” will be understood to include options). For example, a customer operating a customer device may be a broker or other entity desiring to purchase or sell securities using features of embodiments of the present invention. The broker or other entity may be operating on behalf of the ultimate purchaser or seller of the securities.

An order destination 106 may include any computing device(s) operated by or on behalf of one or more order destinations. Each of the order destinations may be in communication with other devices described herein, such as the data source 108, using techniques known in the art. In general, the data source 108 may receive information from the order destinations 106 upon the occasion of each order received by the order destinations and/or after the completion of each trading transaction. Each order destination 106 may include one or more operator terminals allowing specialists or traders at the order destination to respond to orders received and to complete execution of an order pursuant to its terms.

Operator device 109 may, for example, be constituted by a computer terminal or by a computing device such as a PC or a laptop in communication with the trading system 102.

As used herein, devices (e.g., trading system 102, operator device 109, order destinations 106, customer devices 104 and data sources 108) may communicate, for example, via one or more communication networks. For example, some or all of the devices may be in communication via an Internet Protocol (IP) network such as the Internet. Some or all of the devices may be in communication via other types of networks such as an intranet, a Local Area Network (LAN), a Metropolitan Area Network (MAN), a Wide Area Network (WAN), a proprietary network, a Public Switched Telephone Network (PSTN), and/or a wireless network.

According to some embodiments of the present invention, communication between some or all of the devices of trading network 100 may be via a temporary computer communication channel (e.g., a logic path through which information can be exchanged). In other words, the communication channel between various devices may be established and discontinued as appropriate. For example, trading system 102 may exchange information with one of the order destinations 106 only when communication is necessary to transmit an order for execution by the order destination 106 or to receive confirmation from the order destination 106 that the order was executed.

According to some embodiments, some or all of the devices may communicate with other devices via a public computer communication network. That is, at least a portion of the communication network may be accessed by devices other than the devices depicted in FIG. 1. Note, however, that the information exchanged between trading system 102 and other devices in FIG. 1 may be encrypted or otherwise protected to prevent a third party from accessing, manipulating, understanding and/or misusing the information. In some embodiments, some or all of the devices may communicate over a private network.

In some embodiments, the devices of FIG. 1 are connected differently than as shown. For example, some or all of the devices may be connected indirectly to one another (e.g., via the Internet). Of course, embodiments of the invention may include devices that are different from those shown. It should be noted that although the devices of FIG. 1 are shown in communication with each other, the devices do not need to constantly exchange data. Rather, communication may be established when necessary and severed at other times or always available but rarely used to transmit data. Moreover, although the illustrated communication links appear dedicated, it should be noted that each of the links may be shared by other devices.

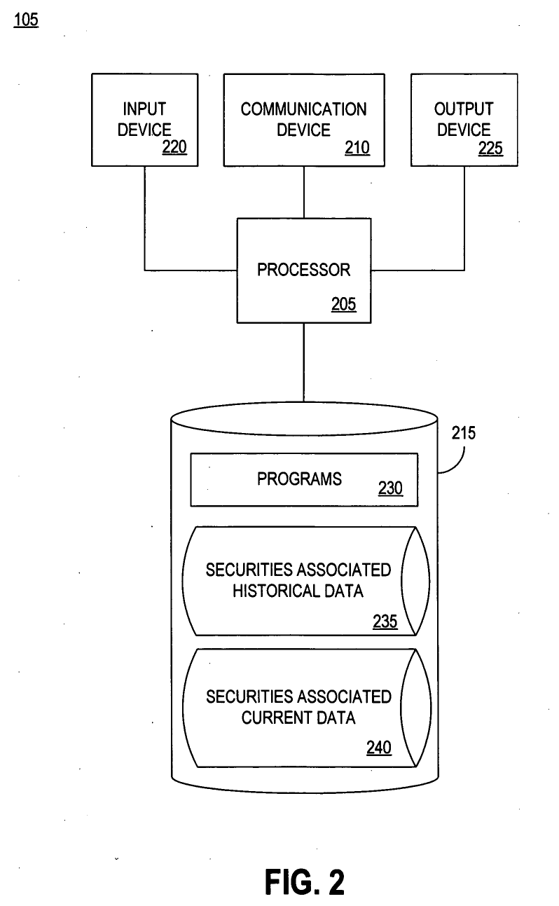

Referring to FIG. 2, an embodiment of order processing server 105 is generally shown. In some embodiments, order processing server 105 includes a computer processor 205 operatively coupled to a communication device 210 and a storage device 215.

Processor 205 may include one or more processors, and may, for example, include RISC-based and other types of processors. Processor 205 operates to execute processor-executable process steps so as to control various aspects of order processing server 105 and to provide desired functionality.

Communication device 210 may be used to facilitate communication with, for example, other devices (such as user devices 110, order destinations 115 and data source 120). Communication device 210 may, in some embodiments, be configured with hardware suitable to physically interface with desired external devices and/or network connections. For example, communication device 210 may include an Ethernet connection to a local area network through which order processing server 105 may receive and transmit information over the World Wide Web.

Storage device 215 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices.

In some embodiments, storage device 215 stores one or more programs 230 for controlling processor 205. Programs 230 may comprise processor-executable process steps of order processing server 105, and may include process steps that include processes provided in accordance with other aspects of the present disclosure to implement a trading strategy to execute a small size trade orders, as further described herein below.

Processor 205 performs instructions of programs 230, and thereby may operate in accordance with the present disclosure. In some embodiments, programs 230 may be configured, at least in part, as a neural network or other type of program using techniques known to those skilled in the art to achieve the functionality described herein. In some embodiments, functionality implemented via programs 230 may include host server functions, order processing, and trade execution functions.

Any or all process steps of order processing server 105 may be read from a computer-readable medium, such as a floppy disk, a CD-ROM, a DVD-ROM, a Zip™ disk, a magnetic tape, or a signal encoding the process steps, and then stored in storage device 215 in a compressed, uncompiled and/or encrypted format. Processor-executable process steps being executed by processor 205 may typically be stored temporarily in RAM (not separately shown) and executed therefrom by processor 205. In some alternative embodiments, hard-wired circuitry may be used in place of, or in combination with, processor-executable process steps for implementation of processes according to embodiments of the present invention. Thus, embodiments of the present invention are not limited to any specific combination of hardware and software.

Storage device 215 may also store databases, including, for example, a database 235 containing historical current market condition data and a database 240 containing current market condition data (e.g., including current quotations for financial instruments). It should be appreciated that other databases may also be provided (e.g., order and execution data may also be stored in storage device 215).

There may also be stored in storage device 215 other (not shown) elements and/or devices that may be used in an operation of order processing server 105, such as an operating system, a database management system, other applications, other data files, and “device drivers” for allowing processor 205 to interface with devices in communication with communication device 210. These other elements and/or devices are known to those skilled in the art, and are therefore not described in detail herein.

Although not shown in the drawing, order processing server 105 may include or be operatively connected to one or more input and/or output devices to permit a system administrator or other user to provide input to the processor 205 or to receive output from the processor 205.

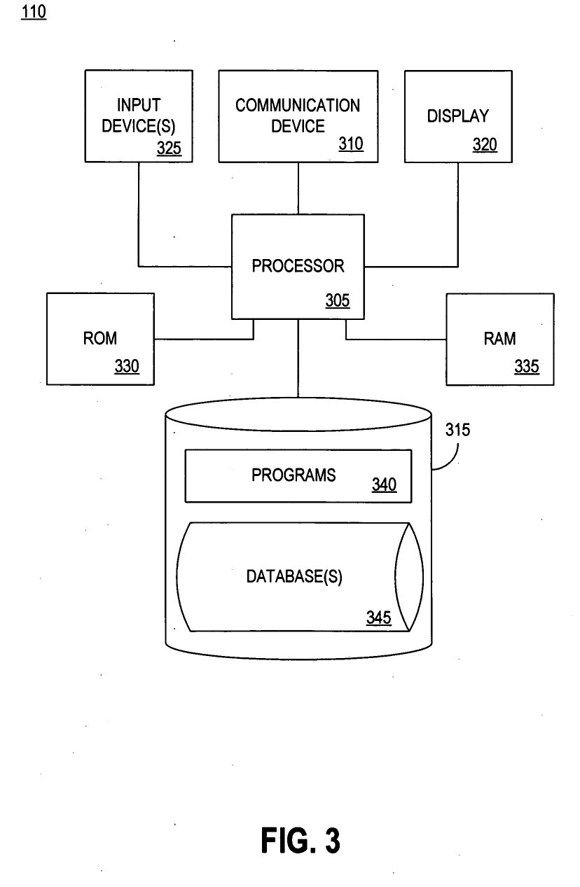

With reference to FIG. 3, there is shown an embodiment of a user device 110. As generally depicted, user device 110 includes a processor 305 operatively coupled to a communication device 310, a storage device 315, a display 320, one or more input devices 325, ROM 310 and RAM 312. Some or all of the hardware constituting user device 110 may be common to conventional personal computer (PC) hardware. Accordingly, processor 305 may be a Pentium® processor, for example, and communication device 310 may include a conventional communication port that enables user device 110 to exchange data with order processing server 105 via, e.g., an Ethernet connection.

Storage device 315 may include a hard disk drive and/or other mass storage device. Display 320 may include a CRT or a LCD flat panel computer monitor. Display 320 may include a screen (not separately shown) on which a user interface in accordance with various aspects of the present disclosure, as described in greater detail below, may be presented to a user of user device 110.

Input devices 325 may include a keyboard, keypad, a scanner, and/or a pointing device such as a mouse or trackball. ROM 330 may store basic input/output instructions and instructions used, for example, during boot-up or initialization of user device 110. In some embodiments, RAM 335 provides fast data storage and retrieval and may thus function as working memory for processor 305. RAM 335, in some embodiments, may temporarily store instructions corresponding to processor-executable process steps being executed by processor 305.

Storage device 315 may store one or more programs 340 that control operations executed by processor 305. Programs 340 comprise processor-executable process steps of user device 110, and may include process steps that constitute processes provided in accordance with various aspects of the present disclosure, as described greater detail herein below. Processor 305 performs instructions of programs 340, and accordingly may effectively operate in accordance herewith. Programs 340 may include, for example, an operating system such as, for example, the Windows® Operating System, as well as device drivers and a client side application that enables user device 110 to interact with order processing server 105. A software program or programs that cause user device 110 to display a user interface (e.g., user input and analysis screen) hereof may reside primarily in order processing server 105 or in storage device 315. In some embodiments, user device 110 may be distributed between order processing server 105, user device 110, another computing device, and combinations thereof.

Storage device 315 may store one or more databases 345 that may be used to store, for example, data downloaded from order processing server 105. This data may include, for example, data concerning current market conditions and/or data indicative of choices that the user of user device 110 may be allowed to make in terms of a desired securities order to evaluate. Other parameters of financial instrument trading orders may also be stored in database 345. Database 345 may store, for example, past desired securities orders evaluated using trading network 100, preferences of the user (e.g., preferred risk tolerance/aversion, securities owned or of interest to the user, attributes of various accounts, etc.).

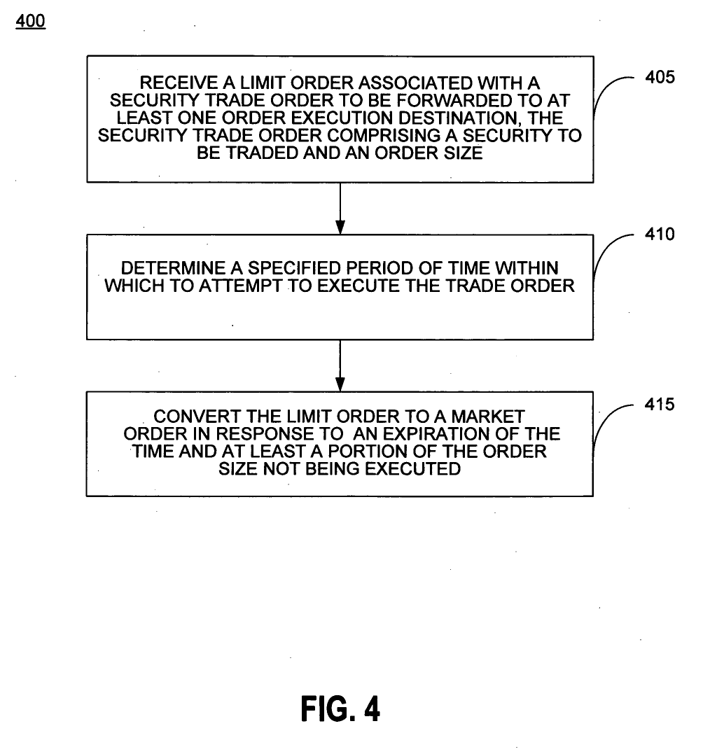

FIG. 4, in accordance with some embodiments herein, is a flow diagram that illustrates an exemplary process for executing a small size trade order of a desired securities order. The process shown in FIG. 4, generally indicated by reference numeral 400, may be performed by the trading system 105 shown in of FIGS. 1 and 2.

At operation 405, trading system 105 receives user input that indicates a desired securities order to execute. The user input may be manually or automatically transmitted and/or generated according to specific or general requests of a user. In some embodiments, the desired securities order to execute may be manually entered into a user device (e.g., user device 110) or automatically generated according to certain criteria such as market conditions, preferred thresholds and limits, economic announcements, etc. The user input of operation 405 may include a number of attributes to identify the desired securities order to execute such as, for example, a type of security, a market destination, a number or size of securities to include in the desired securities order to execute, a Max. Wait Time and a Min. Wait Time during which the desired securities order is to be executed.

In some embodiments, a portion of the user input may include identifying a specific time span for executing a trade order, a relative aggressiveness for executing the trade, a security to trade, a size of the desired trade to execute. For example, regarding a desired securities order, the order may comprise a quote to buy 1,000 shares of a particular stock trading on the NYSE at $25.00 per share. The order includes an identification of the particular stock and the size of the order (e.g., 1,000 shares). Other information transmitted with the order may include, for example, a limit purchase price of $25.00 per share.

At operation 410, system 105 determines a specified period of time within which to attempt to execute the trade order. The specified time may be provided as a minimum wait time (Min. Wait Time) corresponding to a minimum measure of time to wait prior to executing the trade order to facilitate a potential movement in the spread associated with the trade order. The upper time limit may provide a maximum time for executing the trade, in an effort to capture an improved spread, a maximum corresponding to a maximum time allotted for executing the trade, in an effort to capture an improved spread, and a combination thereof. In some embodiments, the desired level of aggressiveness or risk tolerance may be embodied in or related to the Min. Wait Time and Max. Wait Time. It should be appreciated that since process 400 provides a mechanism to execute a small size order, the specified time, based on the Min. Wait Time and Max. Wait Time in some embodiments, at operation 410 may be varied to reflect or correlate to a particular client, customer, trader, market, security being traded. That is, the specified time may be varied to customize a trading strategy implemented thereby.

At operation 415, the desired securities trade order is converted from a limit order to a market order in response to an expiration of the specified time and at least a portion of order size not yet having been executed. In an event that all of the desired trade order is executed prior to the expiration of the specified time, then there is no portion of the quoted trade order size to convert to a market order.

In some embodiments herein, the trade order is converted a market order to capture an improved price that may be reflected in a movement of the spread between the quoted spread at the time the trade order is placed and the spread that may be captured at a time the trade is actually executed. The effective spread of the trade may be enhanced, improved, maximized within an acceptable trade execution timing period or optimized by setting, determining, and varying the specified time of operation 410.

Process 400 may be provided as part of at least one of a plurality of security trading algorithms, at least one of which is used thereby to execute small size orders. The at least one of the plurality of security trading algorithms used to execute small size orders may comprise a number of logic-based rules for guiding the trading of the desired securities order. Note, process 400 may further include a process (either separate or part of those depicted in FIG. 4) of providing the user an opportunity to selectively designate the specified time limits for executing the trade or another factor of the algorithm invoked to execute the small size orders.

In some embodiments, a user or other entity may select from a number of the plurality of trading algorithms (also referred to as a trading “strategy”). In some instances, the plurality of trading algorithms available for selection by a user may be determined and/or limited by the security being traded, the size of the trade order, the specific execution timing strategies used, and other criteria.

It should be appreciated that the various operations of process 400 may vary in order, unless specifically disclosed herein as being contrary to the present disclosure. The sequence of operations in FIG. 4 is provided by way of example.

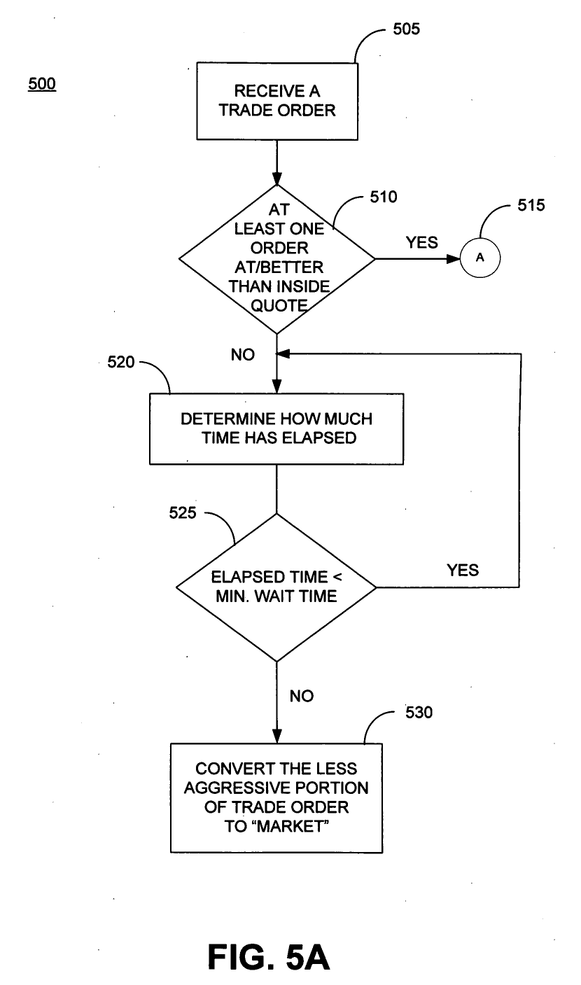

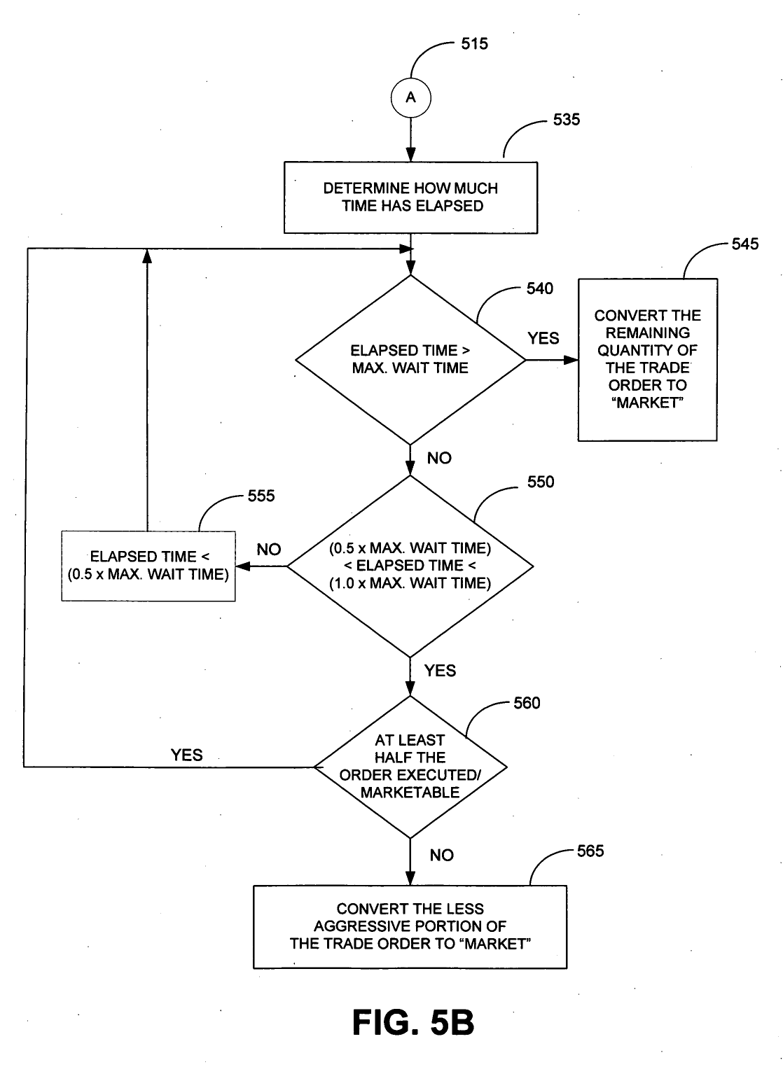

FIGS. 5A and 5B illustrate an exemplary flow diagram of a process 500 in accordance with some embodiments herein. At an initial operation 505, a trade order is received at a trading system for execution thereof. The trade order may be received by market maker, a trader, a specialist, or the like. Operation 505 may also include a process of splitting the received into two or more equal round lots. The received trade order may be split halves of equal round lots. In an instance the size of the trade order is less than the 2 round lots, then there is no second half.

At operation 510, a determination is made whether at least one received order is at or better than an inside quote. In the instance the answer to the determination is “YES”, process 500 proceeds to 515, that is continued in FIG. 5B.

In the instance the determination of operation 510 is “NO”, a determination at operation 520 is initiated to determine how much time has elapsed since the trade order was received. At operation 525, a comparison of the elapsed time versus a specified time is made. The specified time may be a minimum wait time (Min. Wait Time) that is indicative of a minimum time to wait prior to executing the trade order. The Min. Wait Time may be set or determined by a trader and automatically generated based on characteristics of the order being executed (e.g., particular security, size of order, market conditions, etc.). In an instance the elapsed time is less than the Min. Wait Time, the process returns to a point prior to operation 520.

In an instance the elapsed time is greater than the Min. Wait Time, as determined at operation 525, the process proceeds to convert the trade order to a market order to capture favorable movements in the spread occurring between placement of the order and execution of the order. In some embodiments, a less aggressive portion of the trade order (e.g., one of the two halves partitioned from the original order size) is converted to reflect current market conditions at the time of execution.

Referring to FIG. 5B and proceeding from 515 to operation 540, a determination is made of whether an elapsed time since the order was received exceeds a maximum wait time (Max. Wait Time). A comparison of the elapsed time versus a specified time (e.g., the Max. Wait Time) is made. The specified time may be indicative of a maximum time within which to execute the trade order. The Max. Wait Time may be set or determined by a trader and automatically generated based on characteristics of the order being executed (e.g., particular security, size of order, market conditions, etc.).

In an instance the answer to the determination of operation 540 is “YES”, the process proceeds 545 to convert a portion of the trade order to a reflect market conditions. The portion of the order that may be converted may be a remaining portion of the order not yet executed.

In the instance the determination of operation 540 is “NO”, a determination at operation 550 is initiated to determine whether the elapsed time is within a range of time, as illustrated. The particular range of time may be varied to accommodate different clients, size of the order, market conditions, etc. If it is determined that the elapsed time is less than a specified time (e.g., 0.5×Max. Weight Time) then process 500 returns to a point prior to operation 540.

If it is determined that the elapsed time is within a specific range (e.g., (0.5×Max. Weight Time)<elapsed time<(1.0×Max. Weight Time), process 500 proceeds to operation 560. At operation 560, if at least half of the order has yet to be executed process 500 returns to a point prior to operation 540. If less than half of the order has yet to be executed, process 500 proceeds to operation 565. Operation 565 converts a portion of the order, in some embodiments a less aggressive portion of the order, to capture current market conditions at the time of executed.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
receiving a limit order associated with a security trade order to be forwarded to at least one order execution destination, the security trade order comprising a security to be traded and an order size;
determining a specified period of time within which to attempt to execute the trade order; and
converting the limit order to a market order in response to an expiration of the time and at least a portion of the order size not being executed.

2. The method of claim 1, wherein the specified period of time is a maximum wait time indicative of a maximum period of time to expire before converting the limit order to a market order.

3. The method of claim 1, wherein the specified period of time is a minimum wait time indicative of a minimum period of time to expire before attempting to execute the trade order.

4. The method of claim 1, further comprising selectively executing, after the conversion to the market limit, the trade order.

5. The method of claim 1, wherein the specified time is determined to facilitate capturing a spread based on movement from a limit price of the limit order.

6. The method of claim 5, wherein the captured spread comprises an effective spread that is a difference between an execution price for the trade and a midquote price for the security at that time the trade order was received.

7. The method of claim 1, wherein the size of the order for the security to be traded is less than or equal to 0.1 percent of the traded average daily volume (ADV) for the security to be traded.

8. The method of claim 1, further comprising dividing the size of the trade order into two round lots.

9. The method of claim 1, further comprising setting a limit price for one of the round lots.

10. A system comprising:
a processor; and
a storage device in communication with the processor and storing instructions adapted to be executed by the processor to:
receive a limit order associated with a security trade order to be forwarded to at least one order execution destination, the security trade order comprising a security to be traded and an order size;
determine a specified period of time within which to attempt to execute the trade order; and
convert the limit order to a market order in response to an expiration of the time and at least a portion of the order size not being executed.

11. The system of claim 10, wherein the specified period of time is a maximum wait time indicative of a maximum period of time to expire before converting the limit order to a market order.

12. The system of claim 10, wherein the specified period of time is a minimum wait time indicative of a minimum period of time to expire before attempting to execute the trade order.

13. The system of claim 10, further comprising selectively executing, after the conversion to the market limit, the trade order.

14. The system of claim 10, wherein the specified time is determined to facilitate capturing a spread based on movement from a limit price of the limit order.

15. The system of claim 14, wherein the captured spread comprises an effective spread that is a difference between an execution price for the trade and a midquote price for the security at that time the trade order was received.

16. The system of claim 10, wherein the size of the order for the security to be traded is less than or equal to about 0.1 percent of the traded average daily volume (ADV) for the security to be traded.

17. The system of claim 10, further comprising dividing the size of the trade order into two round lots.

18. The system of claim 10, further comprising setting a limit price for one of the round lots.

19. An article, comprising:
a storage medium having stored thereon instructions that when executed by a machine result in the following:
receiving a limit order associated with a security trade order to be forwarded to at least one order execution destination, the security trade order comprising a security to be traded and an order size;
determining a specified period of time within which to attempt to execute the trade order; and
converting the limit order to a market order in response to an expiration of the time and at least a portion of the order size not being executed.

20. The article of claim 19, wherein the specified period of time is a maximum wait time indicative of a maximum period of time to expire before converting the limit order to a market order.

21. The article of claim 19, wherein the specified period of time is a minimum wait time indicative of a minimum period of time to expire before attempting to execute the trade order.

22. The article of claim 19, further comprising instructions stored thereon that when executed by a machine result in selectively executing, after the conversion to the market limit, the trade order.

23. The article of claim 19, wherein the specified time is determined to facilitate capturing a spread based on movement from a limit price of the limit order.

24. The article of claim 23, wherein the captured spread comprises an effective spread that is a difference between an execution price for the trade and a midquote price for the security at that time the trade order was received.

25. The article of claim 19, wherein the size of the order for the security to be traded is less than or equal to about 0.1 percent of the traded average daily volume (ADV) for the security to be traded.

26. The article of claim 19, further comprising instructions stored thereon that when executed by a machine result in dividing the size of the trade order into two round lots.
